(19) United States
(12) Patent Application Publication
(10) Pub. No.: US 2008/0100258 A1
(43) Pub. Date: May 1, 2008

(54) HYBRID VEHICLE WITH ADJUSTABLE MODULAR SOLAR PANEL TO INCREASE CHARGE GENERATION

(76) Inventor: Thomas A. Ward, Moraga, CA (US)

Correspondence Address: FLIESLER MEYER LLP, 650 CALIFORNIA STREET, 14TH FLOOR, SAN FRANCISCO, CA, 94108, US

(21) Appl. No.: 11/969,144

(22) Filed: Jan. 3, 2008

Related U.S. Application Data
(60) Provisional application No. 60/891,356, filed on Feb. 23, 2007.
(60) Provisional application No. 60/956,647, filed on Aug. 17, 2007.

(30) Foreign Application Priority Data
Aug. 23, 2006 (US) PCT/US2006/033166

(51) Int. Cl. H01M 10/46

(52) U.S. Cl. 320/101

(57) ABSTRACT

Solar cells are attached to vehicle components such as a moon roof (2) or truck bed cover (12, 13) to create modular solar panels. An adjustable mount (4, 10) can be attached to the solar panels to adjust the angle of the solar cells in a direction of the sun. Sensing for solar tracking the sun angle can be performed using solar cells of the solar panel itself, or a separate sensor (7). A telescoping moon roof mount mechanism (16) can allow a first solar panel (17) to be extended above a vehicle roof to allow additional solar panels (18, 19) to be telescoped out and also exposed to the sun. An additional battery (15, 100) can be mounted in the truck bed cover and connected in parallel with the hybrid battery (42).

### CLAIM OF PRIORITY

This application is a Continuation-In-Part under 35 U.S.C. 111(a) of PCT Patent Application Number PCT/US2006/033166, with filing date 23 Aug. 2006, entitled “Hybrid Vehicle With Modular Solar Panel and Battery Charging System To Supplement Regenerative Braking,” which claims priority to U.S. Provisional Application Ser. No. 60/710,996 filed Aug. 24, 2005, U.S. Provisional Application Ser. No. 60/714,688 filed Sep. 6, 2005, and U.S. Provisional Application Ser. No. 60/816,956 filed Jun. 27, 2006, all of which are incorporated herein by reference in their entirety.

This application also claims priority to the following provisional applications, each of which is incorporated herein by reference in their entirety: U.S. Patent Application Ser. No. 60/956,647 filed Aug. 17, 2007 entitled “Hybrid Vehicle With Adjustable Solar Panel, Telescoping Additional Solar Panels, and Current Limiting Parallel Battery Charging System To Supplement Regenerative Braking;” and U.S. Patent Application Ser. No. 60/891,356 filed Feb. 23, 2007 entitled “Hybrid Vehicle With Angle Adjustable Solar Panel and Parallel Battery Charging System To Supplement Regenerative Braking.”

### BACKGROUND

1. Technical Field

The present invention relates to a system for increasing the charge generation capability when using solar energy to charge the battery of an electric vehicle.

2. Related Art

Electric vehicles are typically driven by charge stored in a battery and can be charged by a solar panel mounted on the vehicle. Hybrid vehicles are driven by a combination of a battery powered electric motor and a fuel burning motor. Batteries of the electric motor in either drive system can be recharged during operation using solar energy as well as regenerative braking to increase the miles the vehicle can travel. Currently a full day of charging using a one square meter solar panel can typically only provide charge to drive a conventional economy sized vehicle less than 50 miles. It is desirable to provide systems to increase the charge generation ability that solar panels can provide to an electric or hybrid vehicle.

### SUMMARY

Embodiments of the present invention provide a system for charging a vehicle battery using one or more modular solar panels included in a moon roof or on a truck bed cover. These solar panels can include an adjustment mechanism to increase exposure of the solar panel to the sun.

In one embodiment, the optimum angle of adjustment for the solar panel is controlled in the moon roof or truck bed cover or other vehicle mounted solar panel to direct the solar panel toward the sun. The system includes a solar tracker with an automatic angle adjustment mechanism and a sensor to detect the position of the sun. In one embodiment, the solar tracker determines the adjustment angle by a measurement of sun intensity directly from the current measured from the solar cells of the solar panel. Alternatively, the optimum angle of adjustment can be determined using a sensor, separate from the solar panel, which is attached to the solar panel or near the solar panel and provides an indication of the direction of the sun.

In some embodiments, the moon roof, or other attached solar panel can have additional solar panels horizontally extendable to provide more solar charging energy. For the moon roof, the panel can first be extended vertically above the plane of the vehicle roof. Additional solar panels can then extend horizontally from the moon roof to increase overall solar panel area. The additional solar panels can be controlled in some embodiments to extend when the vehicle is parked so that the vehicle movement will not damage the thin solar panels. The angle of the extended solar panels can in some embodiments further be adjusted to direct the solar panels toward the sun.

### BRIEF DESCRIPTION OF THE FIGURES

Further details of the present invention are explained with the help of the attached drawings in which:

FIG. 1 illustrates a vehicle showing solar panel placement in a moon roof with an angle adjustment device and solar tracking sensing using the solar panel;

FIG. 2 illustrates an angle adjustable moon roof solar panel with a separate sensor for solar tracking;

FIG. 3 illustrates an angle adjustable moon roof solar panel that opens in an opposing direction to FIGS. 1 and 2;

FIG. 4 illustrates solar panel placement on a truck bed cover that can be adjustable for solar tracking;

FIG. 5 illustrates multiple solar panels included in a truck bed cover;

FIG. 6 shows batteries provided in a truck bed cover to be charged by solar panels as shown in either FIG. 4 or FIG. 5;

FIG. 7 shows a perspective view of a moon-roof supporting a solar panel configured to extend vertically from the roof of a vehicle, and then additional solar panels telescope out horizontally from the moon roof;

FIG. 8 shows a cross sectional top view of the moon roof solar panel system of FIG. 7 illustrating components for extending additional solar panels horizontally from the moon roof;

FIG. 9 shows a cross sectional side view of the moon roof solar panel system of FIG. 7 illustrating components for extending the moon roof vertically above the vehicle roof;

FIG. 10 illustrates a vehicle with a solar panel attached externally to vehicle roof rails;

FIG. 11 illustrates how the solar panel of FIG. 10 can include a telescoping additional solar panel;

FIG. 12 illustrates a battery case with separate low voltage battery cells connected in series by circuitry on the case lid to provide a high voltage combined battery;

FIG. 13 shows a block diagram for a solar panel battery charging system in combination with a hybrid vehicle battery charging system;

FIG. 14 shows a block diagram for an embodiment of components of a solar battery charging system for use with an electric vehicle with regenerative braking that uses a DC-DC converter to increase voltage from a low voltage solar panel to a high voltage battery;

FIG. 15 illustrates a series battery charger used to enable charging of a high voltage battery by a low voltage solar panel;

FIG. 16 shows an alternative switch configuration to the configuration of FIG. 15 for a series battery charger;

FIG. 17 illustrates an embodiment for a series battery charger wherein the series connection of individual battery cells in a battery pack are broken and the solar panel is connected in parallel with all of the battery cells to enable charging of the battery cells concurrently;

FIG. 18 illustrates components used with a solar system for charging an additional battery connected in parallel with a battery charged by regenerative braking, with diode buffering to prevent charging of the additional battery by regenerative braking; and

FIG. 19 shows modification to FIG. 18 to replace single direction buffering between the parallel batteries with a bi-directional current limiter to prevent overheating of the additional battery during discharge.

### DETAILED DESCRIPTION

I. Modular Solar Panels

The solar panels in some embodiments of the present invention are provided as modular units that replace vehicle components. Such modular panels include a moon roof and a truck bed cover. The modular solar panels are easy to repair and replace and can be provided as an after market item for a vehicle. Although the solar panels can produce a lower voltage than typically required for charging a high voltage battery pack of the vehicle, charging systems are provided in embodiments of the present invention to allow a low voltage solar panel to charge a high voltage battery.

The solar panels increase fuel mileage of a hybrid vehicle or increase battery life of an electric vehicle by charging batteries in combination with regenerative braking. The fueled engine used in a hybrid vehicle with embodiments of the present invention can be gasoline, diesel, bio-diesel, natural gas, propane, or steam. In some embodiments, a battery charged electric motor can be used without a separate fueled engine. Also a hydrogen fuel cell can be used to produce electricity for an electric motor separate from the battery, and can thus be used with only an electric motor, with the solar panel powering the separate battery.

A. Moon Roof Solar Panel

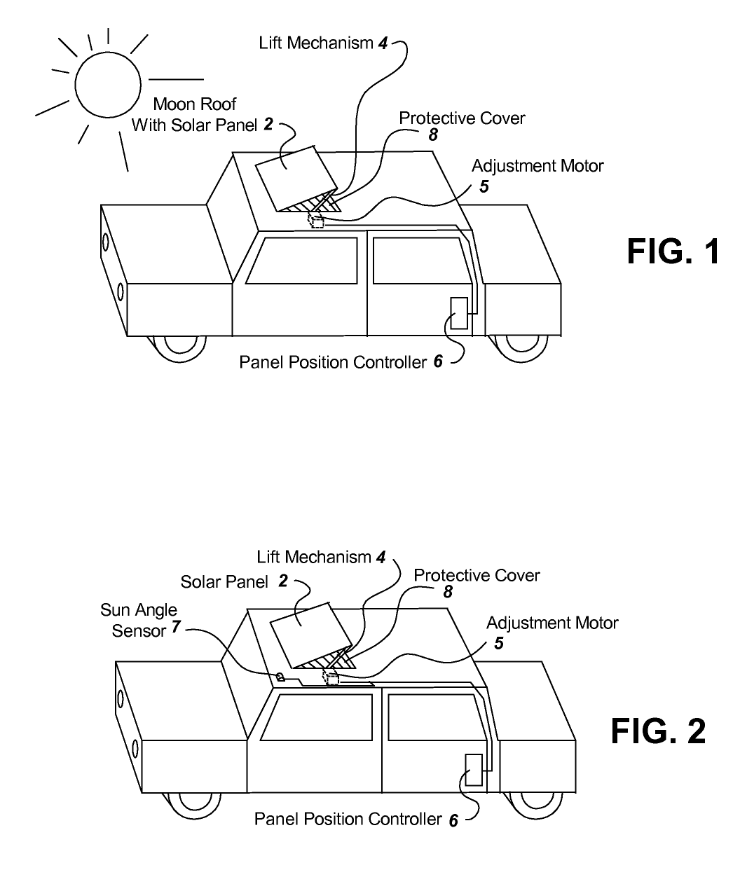

FIG. 1 illustrates a vehicle showing a solar panel 2 placed in the moon roof (also called sun roof). The solar cells making up solar panel 2 can be attached beneath the window of the moon roof with a bottom covering supporting the solar cells and covering the electrical lines. The moon roof typically already includes a glass panel, and electrical lines to run a motor to operate the moon roof. Electric cables for the solar panel 2 can be run through the same lines or openings as the motor electrical connections for the moon roof in the vehicle. The moon roof solar panel 2 can, thus, be a stand alone component, and provided either by a vehicle manufacturer or as an after market device. Use of a solar panel 2 in a moon roof will not significantly change the appearance of a vehicle.

Moon roof as described herein includes a device installed in an opening in the roof of a vehicle and can include a transparent cover (glass, Plexiglas, etc.). The moon roof typically fits flush with the surface of the roof to reduce wind resistance. It can be placed above the driver, or farther back above the rear seat passengers, or in both locations. Rubber or other insulating material that seals around the moon roof transparent cover can provide weather protection for the solar cells. The solar cells can be mounted on a panel beneath the moon roof transparent cover and attached to the support mechanism for the moon roof. Alternatively, the moon roof transparent window can be replaced by the solar panel, or the solar panel can be attached either below or above the transparent moon roof window. As a further alternative, an opening can be cut in a roof of a vehicle without a moon roof for installation of the solar panel built into a moon roof.

FIGS. 1 and 2 illustrate that an angle adjustment lift mechanism 4 that can be used with the moon roof solar panel 2 to direct exposure of the solar panel 2 toward the sun so that maximum power can be generated. As shown in FIGS. 1 and 2, the moon roof solar panel 2 can be lifted by an angle adjustment lift mechanism 4 to change its angle using an adjustment motor 5. The motor 5 is controlled by a controller 6 that can operate in together as a single unit with the hybrid system controller, or separately. The controller 6 is, thus, shown close to a typical hybrid battery with controller placement behind a passenger seat or beneath the floorboard of the vehicle.

The controller 6 in one embodiment connects to a power sensor to measure the amount of charge generated at different positions due to the sun position and cause the adjustment motor 5 to adjust the solar panel 2 to different positions until a position of maximum exposure is obtained. In FIG. 1, the power sensor used to determine an optimum angle is a solar cell in the solar panel 2, with current being measured from the solar cell using a processor in the controller 6. Using a solar cell as a sensor, the solar panel 2 can be adjusted until an optimum current level is determined. In FIG. 2, an alternative separate sensor 7 is used that provides a signal to the controller 6 indicating the direction of the sun. The separate sensor 7 is a directional light intensity measurement device can be constructed from multiple solar cells each placed at a different angle, with a meter or processor connected to the individual solar cells to determine which is generating the most current. The separate sensor 7 of FIG. 2 allows an optimum adjustment angle to be determined without moving the solar panel.

The angle adjustment system can optionally be set to readjust at regular intervals, or to put the solar panel 2 in the down position. With the vehicle parked, the solar panel can be regularly adjusted at chosen time intervals and over chosen angular position steps (i.e. 5 degree, 10 degree, or 20 degree intervals). During driving, since the sun can change positions rapidly, the panel 2 can remain down. Components such as the motor 5 and adjustment mechanism 4 can be the existing components provided with the moon roof of the vehicle.

As further shown in FIGS. 1 and 2, a cover plate 8 can be included beneath the solar panel 2 to prevent access to the vehicle with the solar panel 2 raised. This will allow solar panel angle adjustment when the vehicle is parked and unmanned, if the operator is concerned about vehicle break in through the solar panel 2. The cover plate 8 can be configured to separately open, particularly if the operator still wants open air flow.

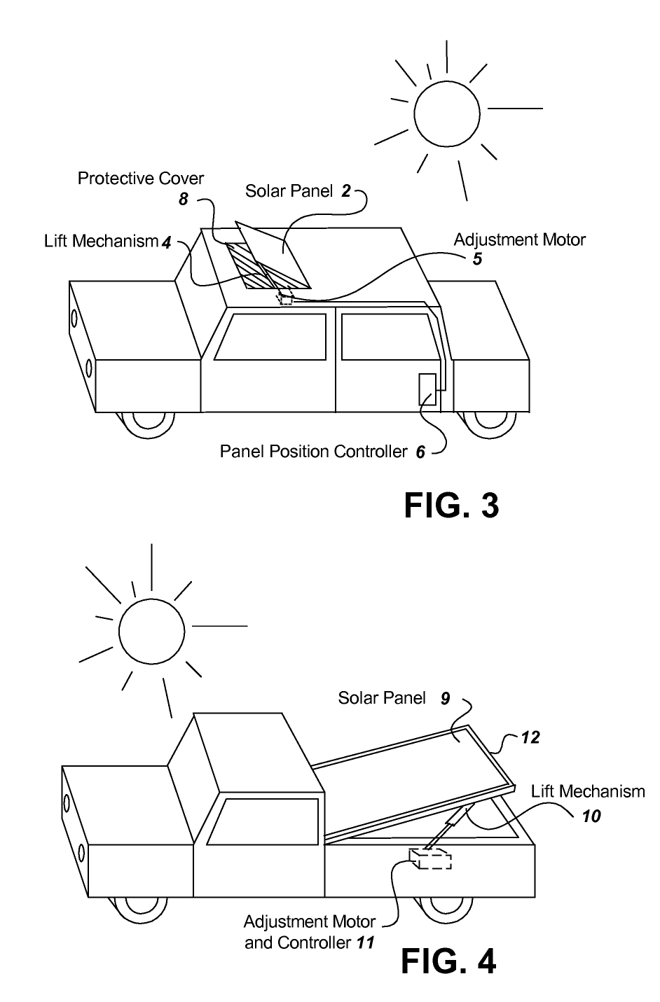

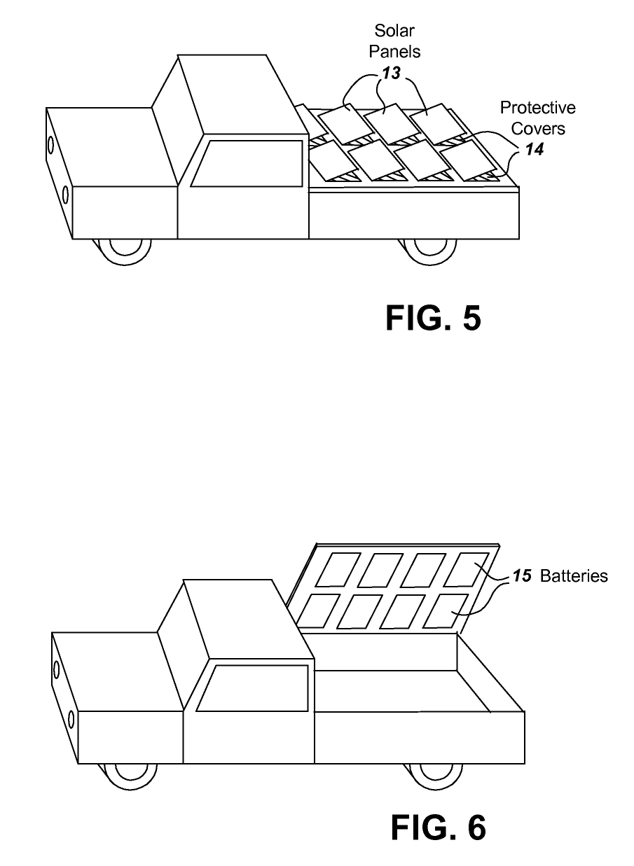

FIG. 3 illustrates that the moon roof solar panel 2 can be adjusted in an opposing manner to face the solar panel toward the rear of the vehicle. This is an atypical adjustment direction to a normal moon roof since it will scoop air into the vehicle during operation. The mode shown in FIG. 3 is, thus, in one embodiment desirable only when the vehicle is parked.

B. Truck Bed Cover Solar Panel

FIG. 4 illustrates solar panel attachment to a truck bed cover 12 to form a modular truck bed cover solar panel 9. The modular truck bed cover solar panel 9 can be easily removed for repair or replacement, and makes the device manufacturable as an after market item for attachment to a truck. The truck bed cover solar panel 9 can be used alone, or in combination with other solar panels placed on the truck if additional battery charging power is desired. In one embodiment, electrical connections from the solar panel to a battery for an electric motor include a pluggable connector that can be unplugged so that the truck bed cover with a solar panel 10 can be removed if the truck bed is needed to carry a large load.

The truck bed cover that covers the entire opening of the pickup truck bed provides a large surface area that can support more solar cells and, thus, provide more charging voltage than comparable solar cells on a moon roof. Accordingly, in one embodiment, the truck bed cover solar panel 9 can charge a battery without requiring a low to high voltage conversion system described subsequently. Further, the truck bed cover solar panel 9 can include an angle adjustment lift mechanism 10 that is operated by motor and controller 11 to adjust the angle to direct the solar panel 9 toward the sun, similar to the moon roof adjustment described in FIGS. 1-3.

Although the entire truck bed is shown lifted by lift mechanism 10, in one embodiment, a smaller panel on the cover can be lifted, or multiple panels 13 as shown in FIG. 4 on the truck bed cover can be separately lifted. Further, the protective covers 14 can be included beneath the truck bed cover as shown in FIG. 4 to protect contents of the truck bed should the solar panel be lifted. In one embodiment, batteries 15 can be attached as shown in FIG. 6 within the truck bed cover that are charged by the individual solar panels 13 of FIG. 4, or a single panel 9 as shown in FIG. 3.

C. Telescoping Moon Roof Solar Panels

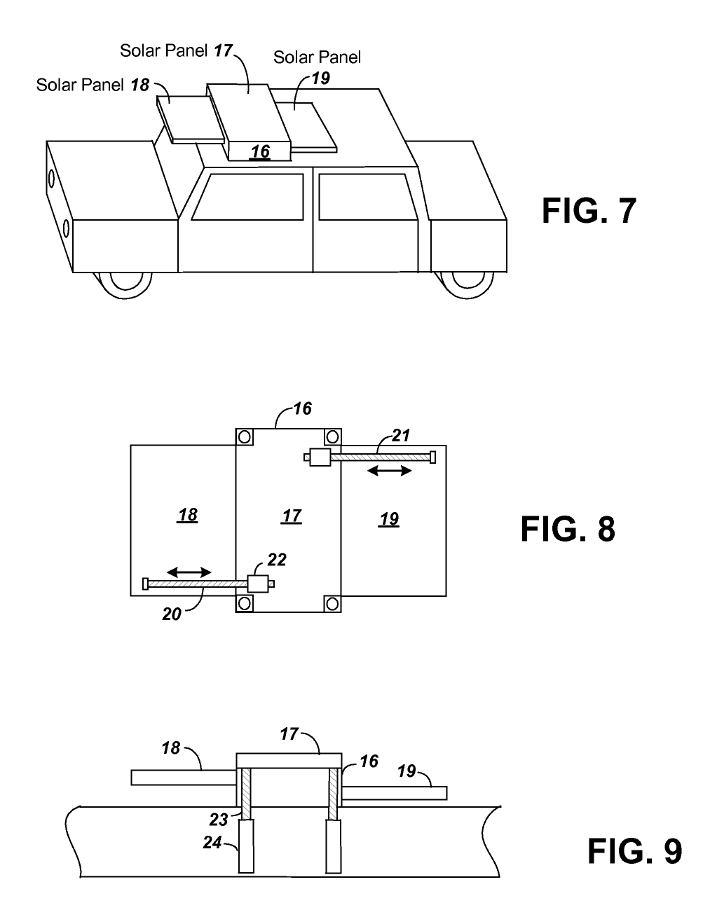

FIGS. 7-9 illustrate how a moon-roof 16 supporting a solar panel 17 can be configured to extend vertically from the roof of a vehicle, and then additional solar panels 18 and 19 can telescope out horizontally from the moon roof 16. Referring initially to the perspective view of FIG. 7, the vertically extending moon-roof 16 allows the moon roof to expose a single solar panel 17 when the moon-roof is retracted to be flush with the vehicle roof. The moon-roof 16 can be extended vertically and additional solar panels 18 and 19 can be telescoped out horizontally to expose additional solar panel surface area to the sun to provide a higher charge current when wind drag is not considered a problem, such as when the vehicle is parked. Solar panels 18 and 19 are shown extending forward over the vehicle roof, and backward over the vehicle trunk. Solar panels can be made to extend from the moon roof 16 horizontally over the doors, but this will extend beyond the surface area of the vehicle potentially enabling the solar panels to strike a vehicle parked next to the vehicle, or strike objects external to the vehicle when it is moving. The moon roof 16 with its solar panels 17-18 can be made to tilt in the direction of the sun, as described previously.

FIG. 8 shows a top cross sectional view of the telescoping moon roof solar panel system illustrating components for telescopically extending additional solar panels 18 and 19 horizontally from the moon roof 16. The components for extending the solar panels 18 and 19 shown include screw type gears 20 and 21. The gear 20 is attached to a motor 22 that can be controlled to turn the screw 20 to extend solar panel 18 when desired. Other drive mechanisms can be used, such as a worm gear or rack and pinion type drive. In any case, a drive mechanism that will be thin is desired to allow all the solar panels 18 and 19 to be retracted and be stored within the car roof without extending significantly into the passenger compartment of the vehicle.

FIG. 9 shows a side cross sectional view of the telescoping moon roof solar panel system illustrating components for extending the moon roof 16 vertically above the vehicle roof. The components for extending the moon roof 16 include a screw 23 and screw drive motor 24. The screw drive motor 24 can be controlled to turn screw 23 to lift the moon roof 16 vertically before the solar panels 18 and 19 are telescoped out. The drive mechanism can include alternative components such as a worm drive or rack and pinion system as long as the entire mechanism remains small enough to not extend significantly into the passenger compartment of the vehicle. Although shown as located on the roof, it is understood that the telescoping moon roof type structure can be installed in other areas of a vehicle, such as in the trunk, or hood of a vehicle.

D. Other Solar Panel Attachment Mechanisms

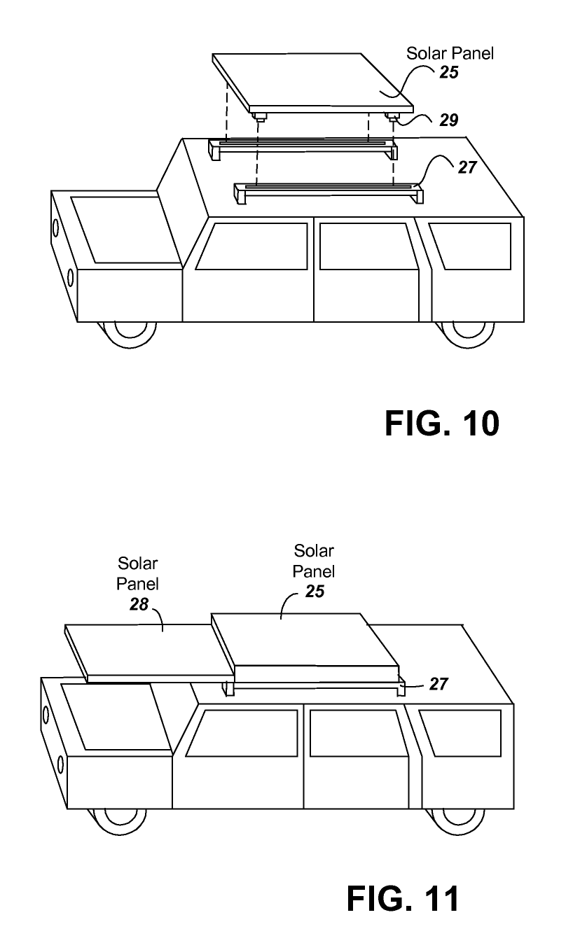

FIG. 10 illustrates a vehicle showing solar panel 25 attachable externally to a vehicle roof. In one embodiment, the solar panel 25 is attached to the vehicle using the roof rails 27 shown. The solar panel can be integrally formed with the cross bar attachments 29, or attached to the cross bars 29. The solar panel 25 can similarly be made to attach directly to the roof rails 27. The solar panel 25 can have a curved leading edge to connect flush with the surface of the car roof to reduce air drag. In an alternative embodiment (not shown) the solar panel can be attached externally to a vehicle using a roof top carrier. The roof top carrier clamps around the door frame or windows of the vehicle and rests on the vehicle top. A similar device can be used to attach a solar panel to the trunk of a vehicle.

FIG. 11 illustrates how the roof mounted solar panel of FIG. 10 can include an additional solar panel 28 that can be telescoped out. The additional solar panel 28 enables additional solar panel surface area to be exposed to the sun, unlike with solar panel 25 alone. The additional solar panel 28 can be extended when the vehicle is parked or otherwise to prevent wind damage to a long thin solar panel that does not have significant mounting structure for stability under a large wind load. Drive mechanisms for extending the solar panels 25 and 28 can be similar to those shown in FIGS. 8 and 9. It is further contemplated that the roof mounted solar panels 25 and 28 can be made to tilt in the direction of the sun for solar tracking, as described for a moon roof and truck bed cover previously.

E. Solar Cell Construction and Attachment

For the above described solar panels, the solar panels can be constructed from individual photovoltaic cells (PVCs) made of material such as silicon, gallium-arsenide, a copper alloy, or similar solar cell material electrically connected together to form a solar panel as desired to provide charge for an electric vehicle battery. The solar panel can be rigid, or flexible, and can be formed as light weight thin film material as known in the art.

A protective transparent covering material can be provided such as glass, Plexiglas, or other transparent polymer to protect the solar cells from the elements. In some embodiments, a sealant is used to seal the solar cells between a transparent layer of material and another layer of material to water proof the solar cells. In some embodiments, the solar cells can be encased in a weather sealing material and a separate cover not used.

For the above described embodiments, attachment of the individual solar cells or solar panels can be accomplished using an adhesive material such as an epoxy or other glue. Attachment can also be accomplished using a magnetic material if later removal is desired. With a glass moon roof, or other nonmagnetic material such as a fiberglass, magnetic material is placed on both sides to attach a solar panel. Alternatively suction cups or clamps can be used to attach to a non-magnetic material.

F. Solar Panel Battery Connection and Placement

As indicated previously, batteries for hybrid vehicles are typically placed in locations away from the passengers, such as behind the rear passenger seat, or beneath a floorboard cover. According to some embodiments of the present invention, to store significantly more charge than can be provided by the original vehicle battery for the electric motor an additional battery or batteries can be used. The additional battery can be connected in parallel to supplement the original vehicle battery, or connected in series to form a battery pack sufficient to run a higher voltage motor. The additional battery can be provided in a similar location to the original battery, such as behind a rear passenger seat, or beneath a floorboard cover. Alternatively, with a solar system in a truck bed cover, the additional battery can be provided in the truck bed cover or in a tool box located in the truck bed. Additional batteries can likewise be placed elsewhere in the vehicle, such as in the trunk or under the hood in the engine compartment. With high voltage devices, however, the batteries and connection cables can be separated from areas where vehicle passengers can access for safety. Although the term battery is used, battery as referenced herein is intended to describe either a rechargeable battery, a capacitor bank, a group of interconnected rechargeable batteries, or other charge storage devices.

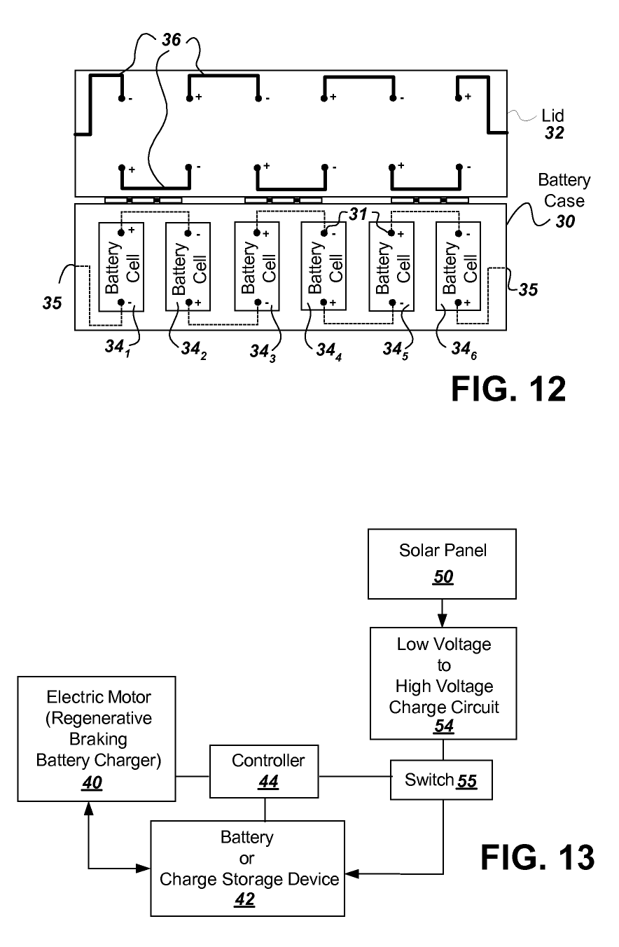

FIG. 12 illustrates a conventional hybrid vehicle battery case 30 with separate low voltage battery cells 34₁₋₆ connected in series by circuitry on the case lid 32 to provide a high voltage combined battery. The battery pack shown includes a lid 32 with a circuit board having trace connections 36 connecting the cells in series. As an alternative to a circuit board, wiring can be provided in the case lid 32 to make battery connections. Although shown with a circuit board making a series connection in the lid of the battery cell container, it is understood that such a series connection system can be placed in other areas of the battery cell container.

The battery with individual series connected cells 34₁₋₆ shown in FIG. 12 allows for connection to a solar charging system for charging of the high voltage battery with a low voltage charging system. A DC-DC converter can be connected across the main terminals 35 of the battery for charging the battery with a low voltage solar panel, potentially without removing the battery lid 32. In some embodiments of the present invention described subsequently, a series charger can be used to connect to terminals 31 of the individual battery cells 34₁₋₆ for charging.

II. Solar Charging Systems

A. System Overview

FIG. 13 shows a block diagram of components for a solar panel charging system in combination with a hybrid vehicle electrical system according to embodiments of the present invention. FIG. 13 includes typical hybrid system components, including an electrical motor 40 for powering the vehicle that also provides for regenerative braking to charge batteries 42. The controller 44 switches the motor 40 so that it can be used to drive the vehicle when battery power is sufficient, and then return to charging the batteries 42 when braking or deceleration of the vehicle occurs. The controller 44 can monitor charge in the battery 42 and provide a signal to a display 46 to alert a vehicle operator of charge on the battery 42, among other things. The controller 44 can also control components in the battery 42, such as a cooling fan.

Additionally in FIG. 13, in accordance with some embodiments of the present invention, a solar panel 50 is added to the system to charge the battery 42. A low voltage to high voltage charge circuit 54 connects the solar panel 50 to the battery 42 through switch 55. In some embodiments, with sufficient voltage from the solar panel 50, the high voltage to low voltage charge circuit 54 can be eliminated. The switch 55, though shown adjacent the battery 42, can be provided in other locations between the battery 42 and solar panel 50. In some embodiments, such as when overcharge of the battery is not a concern, the switch 55 can be eliminated.

The controller 44 is further shown for controlling the solar panel system, although in some embodiments, such as when controls are provided in circuits such as the charger 54, the controller 44 may be provided separately or eliminated when unnecessary. The controller 44 can be a processor, an application specific circuit, a programmable logic device, a digital signal processor, or other circuit programmed to perform the functions described to follow.

The controller 44 can function to control switch 55 to close to allow the solar panel 50 to connect to charge the battery 42, whether or not the electric motor 40 is operating. In other embodiments, when the vehicle electric motor 40 is turned off, the controller 44 connects switch 55 to allow the solar panel 50 to charge the battery 42, but otherwise disconnects the switch 55 during operation of motor 40 to prevent interference with the hybrid charging system. Solar charging during vehicle operation is beneficial because charging can occur during long stretches of highway driving when no regenerative braking is applied so that the batteries 42 can still be charged and the electric motor 40 used to boost fuel mileage. Although charging of the battery 42 when the vehicle is running is beneficial, charging when the vehicle is turned off is also beneficial, for example when a vehicle is parked at a commuter parking lot all day, or for taxis that may wait in the sun for a long time for a fare, since the battery 42 can be fully charged by solar power for use when the vehicle is later operated. The controller 44 can further function to connect and disconnect the switch 55 to prevent overcharging of the batteries 42.

The controller 44 can further control the low voltage to high voltage charge circuit 54 when it is a series charger, as described subsequently, to connect the solar panel 50 to successive individual battery cells.

If a solar panel angle adjustment device is provided, the controller 44 can further function as a controller for solar tracking. The controller 44 operates as a solar tracker by sensing the solar charge current provided at different angles and adjusting the angle of the solar panel to a position of maximum charge production. The controller 44 functioning in this manner provides the function of the solar tracking controller 6 or 11 in FIGS. 1-4. In this function, the controller 44 receives a sensor signal from a sensor described with respect to FIGS. 1 and 2, enabling determination of the position of the sun and control of an angle adjustment device to appropriately position the solar panel.

B. Low Voltage to High Voltage Charging Systems

The solar panel 50 with conventional solar cells occupying a small area, such as in a moon roof, may not provide sufficient voltage to allow charging of a high voltage battery 42. Typical solar systems currently available include solar cells of approximately 0.5 volts and a few milliamps per 1 cm square cell. The solar cells are connected in series so that the voltages are added together to form a 6 to 12 volt system, or possibly a larger voltage if space is available where solar cells are placed. Typical hybrid systems used by auto manufacturers include battery packs ranging from approximately 50 volts where the auto engine is not driven by an electric motor, to a 150 volt battery for a small auto driving motor, approximately 350 volts for a higher power motor, and approximately 500 volts for the current highest power motor. Accordingly, as indicated above, in some embodiments of the invention the low voltage to high voltage charge circuit 54 is used to connect the solar panel 50 to the battery 42.

In some embodiments of the present invention, the low voltage to high voltage charge circuit 54 can be a DC-DC converter to take the low voltage (marked 6-12 volts in figures for illustration as a non-limiting example) from a solar panel, and convert to a high voltage (marked 200-300+ volts in figures for illustration also as a non-limiting example) for charging the vehicle battery 42. In other embodiments, the low voltage to high voltage charge circuit 54 can be a series charger, as described to follow, so that the low voltage solar panel 50 is connected individually to each low voltage series cell in the battery to enable battery charging.

1. DC-DC Converter Charging System

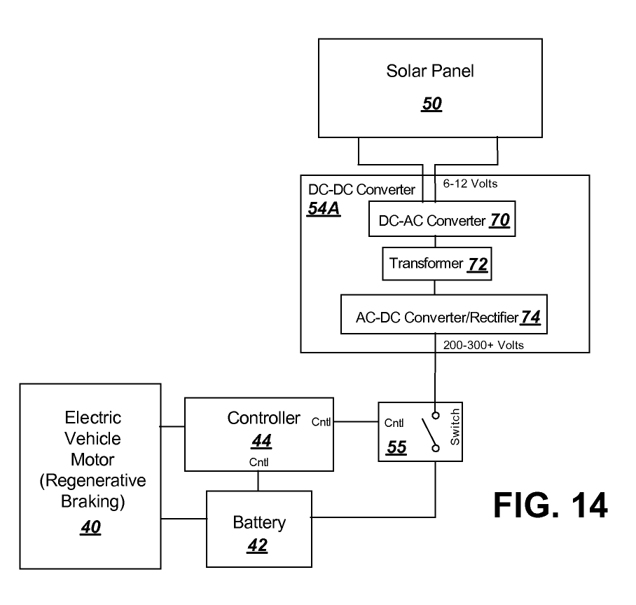

FIG. 14 illustrates components of a solar charging system using a DC-DC converter 54A for the low voltage to high voltage charge circuit 54 of FIG. 13. Note that components carried over from FIG. 13 are similarly labeled in FIG. 14, as will be components carried over in subsequent drawings. The DC-DC converter 54A can contain the minimal components shown including: (1) a DC to AC converter or inverter 70, (2) a transformer 72, and (3) an AC to DC converter or rectifier 74. The DC to AC converter 70 serves to convert the low voltage output of the solar panel 50 to an AC signal. The transformer 72 boosts the AC voltage to a higher AC voltage than the battery 42 as necessary to charge the battery 42, and the rectifier 74 converts the high voltage AC to DC to enable charging of the battery 42. Since the regenerative braking charging system between the electric motor 40 and battery 42 will typically use a similar rectifier to rectifier 74, in one embodiment a common rectifier can be used to reduce overall circuitry. Other alternative components known in the art can be used in the DC-DC converter 70.

The controller 44 is connected to monitor charge on the battery 42 and control switch 55. To prevent overcharging of the battery 42, the controller 44 opens the switch 55 to disconnect the solar panel 50. The controller 44 can further disconnect the switch 55f charging from the solar panel 50 might interrupt operation of the vehicle, or if significant current from the electric motor might damage components of the solar charging system. As indicated previously, the switch 55 can be moved to an alternative location between the battery 42 and solar panel 50.

2. Series Battery Charger Systems

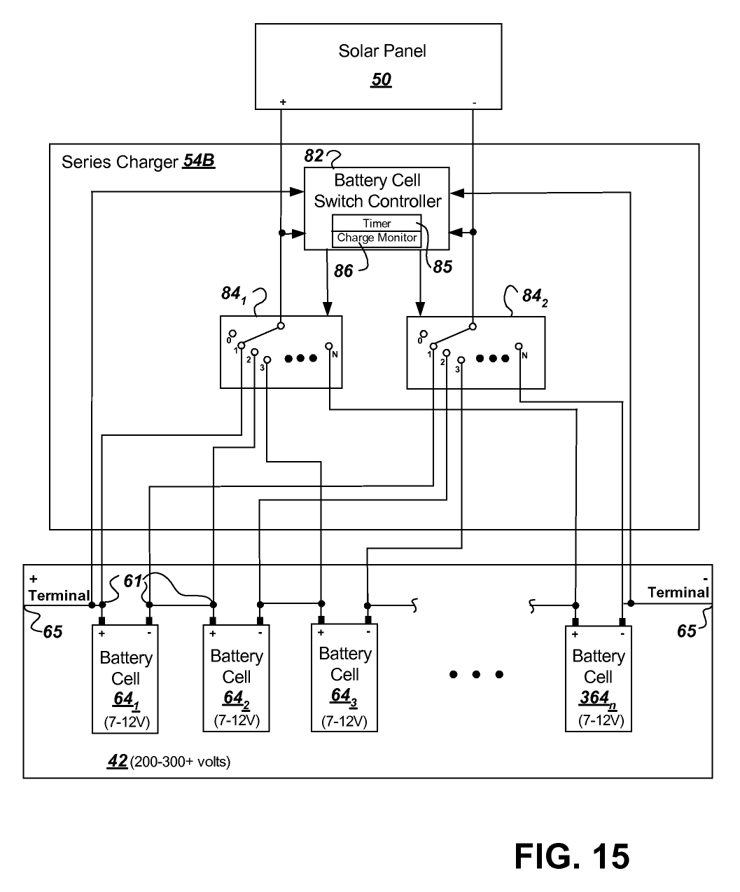

FIG. 15 illustrates one embodiment of a series battery charger 54B for the low voltage to high voltage charging circuit 54 of FIG. 13. The series battery charger 54B provides an alternative to the less efficient DC-DC converter used in prior art solar charging systems. The DC-DC converter typically will experience less than 80% of the efficiency of a series charger 54B. The series charger 54B serves to charge a high voltage battery pack 42 (200-300+ volts) made up of series connected battery cells 34₁₋ₙ. The individual battery cells 34₁₋ₙ can in one non-limiting example be approximately 10 volts each with thirty connected in series to create a 300 volt battery. The series charger 54B makes a connection in parallel with the series battery cells 34₁₋ₙ, one or more at a time using switches 84₁ and 84₂ connected to terminals of the solar panel 50. The switches 84₁ and 84₂ can be electronic switches, relays, transistors, pass gates, tri-state buffers, or other components known in the art used to accomplish switching.

In operation, during charging by the series charger 54B, the solar panel 50 can be connected in parallel across the series connected battery cells 34₁₋ₙ one at a time by moving the position of switches 84₁ and 84₂ from position 1, 2, 3 etc. across the battery cells 34₁₋ₙ without any DC-DC conversion. As an alternative to connecting the solar panel 50 across one of the battery cells, the switches 84₁ and 84₂ can connect across multiple ones of the battery cells 34₁₋ₙ, for example by connecting switch 84₁ to position 1, while switch 84₂ is connected at position 2. Although not specifically shown, it is noted that each of the cells 34₁₋ₙ can each include a number of series connected cells. The solar charging can be performed when the vehicle ignition is off and the electric motor not operating, or when the electric motor is not in use. Solar charging can also be performed during operation of the vehicle electric engine. Solar charging can likewise be performed during application of regenerative braking with sufficient buffering applied to the solar panel 50 and components of the series charger 54B if necessary when regenerative braking current becomes excessive.

The series charger 54B further includes an individual battery cell switch controller 82. The cell switch controller 82 shown includes components to regulate charging of the individual series battery cells 34₁₋ₙ. The cell switch controller 82 can monitor charge on a battery cell being charged using a cell charge monitor 86 and control switches 84₁ and 84₂ to charge another one of the battery cells when sufficient charging has occurred. In this manner cell balancing can be provided using the solar panel to assure each battery cell has substantially the same voltage during charging. This can prevent overcharging of some batteries that charge at a faster rate. In one embodiment, a current sink can be provided to drain power from battery cells for the purpose of providing cell balancing in conjunction with the solar cell, and to enable charging and discharging of cells for cell conditioning needed with some types of batteries. Although a solar panel can be used for cell balancing, in one embodiment a separate cell balancer that uses current from one battery cell to balance its voltage with another battery cell can be used. The separate cell balancer may be particularly used if the solar panel is used to charge groups of batteries connected in series at a time, as individual batteries in each group can remain unbalanced.

Alternatively, the cell charge controller 82 can include a timer 85 and switch from battery cell to battery cell on a timed basis to perform charging. Because cells may charge at different rates, less charge time can be set for cells that charge faster to provide for cell balancing. Cell voltage can be monitored and charging controlled to assure cells are charged to a desired voltage due to different charge rates between batteries.

Once all of the cells 34₁₋ₙ are sufficiently charged, as determined by the controller 82 monitoring the terminals 35 of the entire battery 42, the cell switch controller 82 can move the switches 84₁ and 84₂ to the open circuit switch position 0 to prevent overcharging of the battery 42. Hysteresis can be provided with the cell switch controller 82 allowing the battery 42 to discharge below the maximum charge state before the switches 84₁ and 84₂ are moved back off of the 0 position to avoid rapid turn on and off of the charging system when full battery charge is reached.

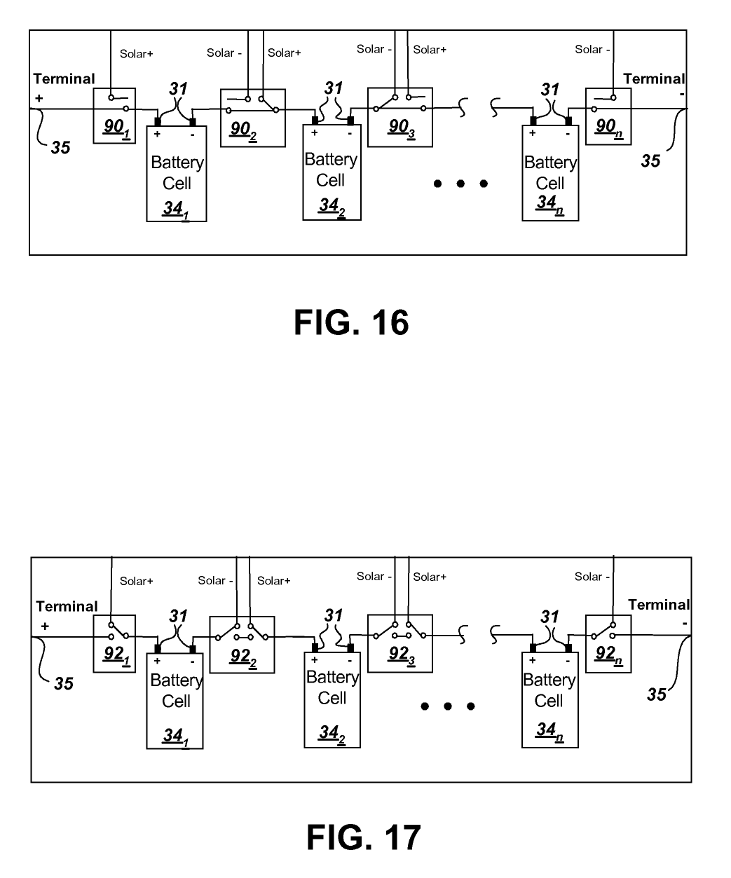

FIG. 16 shows an alternative to the configuration of switches 84₁ and 84₂ of FIG. 15 for a series battery charger. Instead of the two single pole multiple throw switches 84₁ and 84₂, the alternative switches include single pole single throw switches 90₁₋ₙ connected to terminals 31 between each one of the cells 34₁₋ₙ. Although the end switches 90₁ and 90ₙ include a single switch, while the middle switches, such as 90₂, includes two combined switches, it is understood that the middle switches can each be separated into two single pole single throw switches. The switches 90₁₋ₙ selectively connect terminals 31 of the cells 34₁₋ₙ to terminals of the solar panel 50. For purposes of illustration, the cell 34₂ is shown connected by switches 90₁₋ₙ to the solar panel for charging, while the remaining cells are disconnected. The indications solar− and solar+ show connections to specific terminals of the solar panel 50. The alternative switches 90₁₋ₙ of FIG. 15 and switches 84₁ and 84₂ of FIG. 16 illustrate that different switch configurations can be provided to accomplish the same function of connecting the solar panel 50 in parallel across individual ones of the cells 34₁₋ₙ, one or more of the cells at a time.

FIG. 17 illustrates an embodiment for a series battery charger wherein connection to the solar panel 50 as well as the series connections of individual battery cells 34₁₋ₙ is made using switches 92₁₋ₙ. The switches 92₁₋ₙ are single pole double throw switches (although the middle switches, such as 92₂, are shown as double pole double throw switches they can be separated into two single pole double throw switches). The switches 92₁₋ₙ illustrate that the series connection between battery cells 34₁₋ₙ can be broken and a single solar panel 50 connected by its terminals (solar+ and solar−) in parallel across each of the battery cells 34₁₋ₙ to enable charging of all the battery cells 34₁₋ₙ at the same time.

The disconnection of battery cells 34₁₋ₙ, as shown in FIG. 17, by switches 92₁₋ₙ can be performed when the vehicle is not in operation to prevent danger of shock from high voltages, even if the solar panel is not charging. In one embodiment, an inertia shock sensor can be used to switch off the series connection, requiring the ignition to turn off and back on to reset. This can remove high voltages that make rescue dangerous after an accident. During operation of the vehicle, the series connections can then be reconnected by switches 92₁₋ₙ to recreate the 200-300+ volt battery output and the solar panel terminals, solar− and solar+, are disconnected from the battery cells 34₁₋ₙ to stop battery charging during vehicle operation.

In alternative embodiments, combinations of the series charging systems of FIGS. 15-17 can be provided as desired. For example, either of the switching systems for series charging one cell at a time in FIG. 15 or 16 can be combined with the system of FIG. 17 that charges all cells together when the battery cells are not used and are disconnected in series. This combination will still allow charging of the battery cells even when the series connection is made. For the series charging systems shown in FIGS. 15-17, the switches can be provided on a circuit in the lid of the battery case shown in FIG. 12, or they can be provided in a separate housing with interconnecting wiring.

C. Charging System Configurations Using an Additional Battery

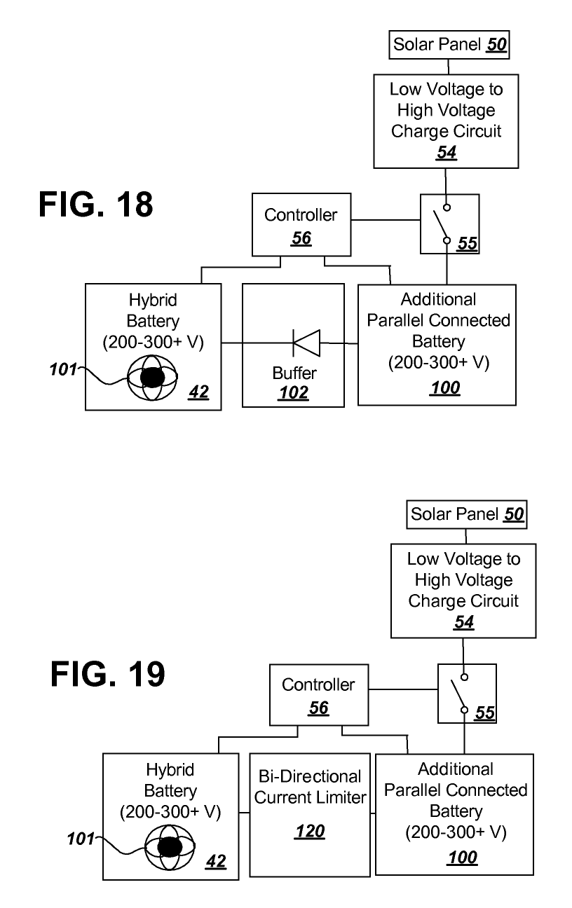

FIG. 18 illustrates components used with a solar charging system having a separate additional battery 100 connected in parallel with battery 42 and charged by the solar charging system. In one embodiment, the separate battery 100 can be the battery cells 15 included in the truck bed cover of FIG. 6. The solar charging system shown includes a solar panel 50 connected through a low voltage to high voltage charging circuit 54. The low voltage to high voltage charging circuit 54 can be either a DC-DC converter, as described with respect to FIG. 14, or a series charger such as described with respect to FIGS. 15-17. A controller 44 monitors solar charging of both batteries 42 and 100 and operates switch 55 to disconnect solar charging to prevent overcharge of the batteries. With a series charger used for the low to high voltage charging circuit 54, the switch 55 will be internally provided and a separate switch will be unnecessary. The additional battery 100 provides added charge storage so that an electric vehicle can travel farther on a full charge.

An added feature in FIG. 18 is that the additional battery 100 can be a lower cost device than battery 42, since the additional battery 100 can be made to not require a cooling system (illustrated by fan 101) to prevent the high regenerative braking charge current from causing overheating if buffer 102 separates the batteries 100 and 42. The regenerative braking charged battery 42 will typically have a cooling system with fans 101 or other components that will be unnecessary with the low current solar charging system. The buffering 102 allows only the solar panel 50 to charge the additional battery 100, since a regenerative braking charging current will blocked by buffer 102 from the additional battery 100. If regenerative brake charging is desired for both batteries 100 and 42, buffering 102 can be removed between the two batteries 42 and 100.

A further added feature of the system of FIG. 18 is provided when the low to high voltage charging circuit 54 is a series charger. First, if the battery 42 is not easily accessible to install a switching circuit for the series charger, the series charger can still be easily connected in the added battery 100. With the battery 100 and battery 42 connected in parallel, the series charger can charge an individual cell of battery 42 and as a consequence will provide current to charge all of the series cells of battery 42. With both batteries 42 and 100 connected, and battery 100 charged to the voltage of battery 42, the voltages will equalize when the additional battery 100 is further charged to effectively charge the battery 42. The battery 42 can, thus, be charged by a lower voltage solar panel without requiring series charging of its individual cells or without requiring DC-DC conversion.

FIG. 19 shows modifications to FIG. 18 to replace the diode buffer 102 with bi-directional current limiting buffer 120. The bi-directional current limiter 120 is provided between the additional battery 100 and the hybrid battery 42 to prevent overheating of the additional battery 100. With current limiting of the bi-directional current limiter 120, cooling of the additional battery, necessary when: (1) charging directly by regenerative braking and (2) discharging to run the electric vehicle motor from both batteries, will thus not be required. Thus, as opposed to the diode buffer 102 of FIG. 18, the bi-directional current limiter 120 will allow the additional battery 100 to assist in driving the electric motor of the vehicle without overheating due to I²R losses though the battery. Further, as opposed to the diode buffer 102 of FIG. 18, the bi-directional current limiter 120 will allow the additional battery 100 to be charged by regenerative braking without overheating. Similar to the diode buffer 102, the current limiter 120 enables the additional battery 120 to charge the additional battery one cell at a time using the solar panel, while effectively charging all of the cells of battery 42 together.

Although shown with a bi-directional current limiter 120, in some embodiments a one directional current limiter can be used in combination with the diode buffer 102 of FIG. 18. A combined diode buffer 102 and one directional current limiter can be desirable when it is undesirable to charge the second battery 100 by regenerative braking. The undesirability of charging second battery 100 can result when the limited regenerative braking charging only supplies enough current to charge the battery 42 above a desired voltage, while if both batteries 100 and 42 are charged from regenerative braking the combined charged voltage may be insufficient to operate the motor for as long a time as when battery 42 is regenerative braking charged alone. The one directional current limiter will limit current from battery 100 toward battery 42 to enable battery 100 to remain cool when a significant amount of current is drawn by the electric motor. The diode buffer 102 will prevent regenerative braking charge current from flowing to battery 100. Specific circuitry for the bi-directional current limiter 120 or for a one-directional current limiter is shown in U.S. patent application Ser. No. 11/877,509, entitled “Current Limiting Parallel Battery Charging System To Enable Plug-In or Solar Power To Supplement Regenerative Braking in Hybrid or Electric Vehicle,” filed Oct. 23, 2007, which is incorporated herein by reference in its entirety.

Although embodiments of the present invention have been described above with particularity, this was merely to teach one of ordinary skill in the art how to make and use the invention. Many additional modifications will fall within the scope of the invention, as that scope is defined by the following claims.

What is claimed is:

1. A solar battery charging system for a vehicle comprising:
a solar panel including solar cells provided in at least one of a truck bed cover and a moon roof,
a tilt angle adjustment mechanism attached to the at least one of the truck bed cover and the moon roof enabling movement of the solar panel according to a direction of the sun;
a sensor for determining a tilt angle of the solar panel where the solar panel provides substantially a maximum output; and
a controller connected to the sensor and tilt angle adjustment mechanism for adjusting the tilt angle adjustment mechanism to the angle determined by the sensor.

2. The solar battery charging system of claim 1, wherein the sensor is formed from at least a given one of the solar cells with electrical output measured from the given solar cell as a tilt angle of the solar panel is changed to determine the direction of the sun.

3. The solar battery charging system of claim 1, wherein the sensor comprises a directional light intensity measurement device electrically separate from the solar panel for determining a direction of the sun.

4. The solar battery charging system of claim 1, further comprising:
an electric motor;
a battery connected to the electric motor, the battery comprising a plurality of series connected battery cells,
wherein the solar panel has a maximum output voltage lower than the maximum voltage of the battery; and
a series charger comprising:
switches that selectively connect terminals of the solar panel in parallel with each of the series connected battery cells; and
a switch controller configured to control the switches to separately connect the solar panel in parallel with each of the series battery cells, one of the battery cells at a time, while the series battery cells, including the battery cell connected in parallel with the solar panel, remain connected in series.

5. A solar charging system of claim 1, wherein the solar panel is provided in a moon roof, wherein the solar panel comprises a first solar panel, the solar charging system comprising:
a second solar panel including multiple solar cells provided in the moon roof with the first solar panel;
a telescoping mechanism for telescopically moving the second panel relative to the first solar panel so that the solar cells of the second solar panel will be alternatively exposed to the sun in addition to the first solar panel in a first position and blocked from the sun by the first solar panel in the second position.

6. The solar charging system of claim 5, wherein the telescoping mechanism lifts the first solar panel vertically above the vehicle roof before telescoping the second solar panel horizontally from beneath the first solar panel for exposure to the sun.

7. The solar charging system of claim 1, further comprising a protective cover provided over an opening formed when the solar panel is moved by the tilt angle adjustment mechanism.

8. A solar battery charging system for a vehicle comprising solar cells forming at least one solar panel provided on a truck bed cover.

9. The solar battery charging system of claim 8, further comprising at least one first battery mounted on the truck bed cover and connected to the at least one solar panel for charging.

10. A solar battery charging system of claim 9, further comprising:
electric motor;
a second battery connected to the electric motor; and
at least one buffer connecting the first battery in parallel with second battery.

11. The solar battery charging system of claim 10, wherein the buffer comprises a bi-directional current limiter.

12. The solar battery charging system of claim 10,
wherein the first battery comprises a plurality of series connected battery cells,
wherein the at least one solar panel has a maximum output voltage lower than the maximum voltage of the first battery,
the solar battery charging system further comprising:
a series charger comprising:
switches that selectively connect terminals of the at least one solar panel in parallel with each of the series connected battery cells; and
a switch controller configured to control the switches to separately connect the at least one solar panel in parallel with each of the series battery cells, one of the battery cells at a time, while the series battery cells, including the battery cell connected in parallel with the at least one solar panel, remain connected in series.

13. A solar battery charging system of claim 8, wherein the at least one solar panel comprises a plurality of solar panels, the system further comprising:
a tilt angle adjustment mechanisms attached to the solar panels enabling movement of the solar panels according to a direction of the sun;
at least one sensor for determining a tilt angle of the solar panels where the solar panels provide substantially a maximum output; and
and at least one controller connected to the at least one sensor and the tilt angle adjustment mechanisms for adjusting the tilt angle adjustment mechanism to the angle determined by the at least one sensor.

14. A solar charging system comprising:
a first solar panel including multiple solar cells;
a second solar panel including multiple solar cells mounted on a vehicle with the first solar panel;
a telescoping mechanism for telescopically moving the second panel relative to the first solar panel so that the solar cells of the second solar panel will be alternatively exposed to the sun in addition to the first solar panel in a first position and blocked from the sun by the first solar panel in the second position.

15. The solar charging system of claim 14, wherein the telescoping mechanism is provided in a moon roof of a vehicle, and wherein the telescoping mechanism lifts the first solar panel vertically above the vehicle roof before telescoping the second solar panel horizontally from beneath the first solar panel for exposure to the sun.
